(19) United States
(12) Patent Application Publication
(10) Pub. No.: US 2007/0198300 A1
(43) Pub. Date: Aug. 23, 2007

(54) Method and system for computing trajectories of chronic disease patients

(76) Inventors: David Wayne Duckert, Menomonee Falls, WI (US); James Steven Cincotta, New Berlin, WI (US); Paul Edward Cuddihy, Ballston Lake, NY (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/358,559

(22) Filed: Feb. 21, 2006

(51) Int. Cl. G06F 19/00; G06F 17/00

(52) U.S. Cl. 705/3; 707/104.1

(57) ABSTRACT

The method and system includes producing a trajectory report to illustrate for the patient the benefit of complying with a prescribed treatment regimen. The method and system collects a set of physiological, self assessment, and compliance data from the patient, accesses a patient medical record database and a de-identified compliance and outcomes database, and calculates a clinical trajectory using a trajectory algorithm. The clinical trajectory is displayed for the patient on a graphical user interface, and illustrates for the patient the results of adhering to a prescribed treatment regimen compared to not adhering to the regimen. The method and system may be applied to any health condition that requires the patient to follow a treatment regimen.

### FIELD OF THE INVENTION

The invention relates to the field of remote monitoring. More particularly, the invention relates to the field of chronic disease monitoring.

### BACKGROUND OF THE INVENTION

For a variety of reasons, monitoring of chronically ill patients in a remote, non-hospital environment will become more common in the near future. The clinical data collected, for example, blood pressure, weight, etc., is transmitted back to a caseworker or clinician who can provide early intervention to prevent re-hospitalizations. By monitoring patients remotely, costly re-hospitalization events can be avoided and the overall cost of managing the disease can be reduced.

However, patients are often non-compliant with treatment regimens, and often skip medications because of side effects or because they “feel fine now.” They often ignore dietary restrictions, such as sodium intake, and fail to regularly record vital sign measurements (weight, blood pressure, glucose levels, etc.) on their own.

One possible reason for this behavior is the lack of immediate feedback from the caseworker or clinician. Under the current system, patients receive feedback from the caseworker or clinician on their current health status only at office visits, which are often months apart. With improvements and innovations in remote monitoring systems, monitoring and feedback can be provided more frequently and effectively.

As an example, a congestive heart failure (CHF) patient participates in an office visit with his doctor, the doctor outlines a treatment regimen consisting of several medications, a low sodium diet, moderate exercise and daily weight and blood pressure measurements. The patient may comply with the treatment regimen for a few days and begin to feel better. The patient then reverts to eating salty foods or skipping exercise sessions, which seem to have no negative effects. The long-term effect of this behavior is not obvious to the patient. Eventually, however, due to the patient's poor adherence to the treatment regimen, his condition deteriorates to the point where an acute intervention is required. The patient may need to be hospitalized or the patient's disease may have advanced to the next stage. After the acute intervention, the patient may become more compliant with the treatment plan, but soon begins feeling better and the cycle repeats itself.

### SUMMARY OF THE INVENTION

The method and system includes producing a trajectory report to illustrate for the patient the benefit of complying with a prescribed treatment regimen. The method and system collects a set of physiological data from the patient, accesses a patient medical record database and a de-identified compliances and outcomes database, and calculates a clinical trajectory using a trajectory algorithm. The clinical trajectory is displayed for the patient on a graphical user interface, and illustrates for the patient the results of adhering to a prescribed treatment regimen compared to not adhering to the regimen. The method and system may be applied to any health condition that requires patient adherence to a treatment regimen.

In one aspect of the present invention, a method of computing a set of clinical trajectories of a chronic disease patient includes collecting a set of patient data from the chronic disease patient, accessing a database for a set of compiled data and calculating the set of clinical trajectories with a trajectory algorithm wherein the trajectory algorithm utilizes the set of remote patient data and the set of compiled data. The database may include a patient medical record database and a de-identified compliance and outcome database. The set of clinical trajectories includes a compliance trajectory, the compliance trajectory illustrating a first predicted patient condition when the chronic disease patient adheres to a prescribed treatment regimen, a first non-compliance trajectory, the first non-compliance trajectory illustrating a second predicted patient condition when the chronic disease patient does not adhere to the prescribed treatment regimen and a second non-compliance trajectory, the second non-compliance trajectory illustrating a third predicted patient when the chronic disease patient partially adheres to the prescribed treatment regimen. The method further comprises producing a trajectory report, wherein the trajectory report includes a comparison of any of the set of clinical trajectories, and displaying that trajectory report on a graphical user interface.

In another aspect of the present invention, a system for computing a set of clinical trajectories of a chronic disease patient includes a remote sensing system configured to collect a set of patient data from the chronic disease patient, a storage media for storing a computer application and a processing unit coupled to the remote sensing system and the storage medium and configured to execute the computer application, and further configured to receive the set of patient data from the remote sensing system, wherein when the computer application is executed, a database having a set of compiled data is accessed and the set of clinical trajectories is calculated with a trajectory algorithm, and further wherein the trajectory algorithm utilizes a set of remote patient data and a set of compiled data when the trajectory algorithm calculates a set of clinical trajectories. The database may include a patient medical record database and a de-identified compliance and outcomes database. The set of clinical trajectories includes a compliance trajectory, the compliance trajectory illustrating a first predicted patient condition when the chronic disease patient adheres to a prescribed treatment regimen, a first non-compliance trajectory, the first non-compliance trajectory illustrating a second predicted patient condition when the chronic disease patient does not adhere to the prescribed treatment regimen and a second non-compliance trajectory, the second non-compliance trajectory illustrating a third predicted patient condition when the chronic disease patient partially adheres to the prescribed treatment regimen. The system also includes a trajectory report produced when the trajectory algorithm calculates a set of clinical trajectories, wherein the trajectory report includes a comparison of any of the set of clinical trajectories, and a graphical user interface configured to display the trajectory report.

### BRIEF DESCRIPTION OF THE DRAWINGS

FIG. 1 illustrates a flow chart of a method in accordance with an embodiment of the present invention.

FIG. 2 illustrates a block diagram of a method in accordance with an embodiment of the present invention.

FIG. 3 illustrates a graphical representation of an exemplary trajectory report in accordance with an embodiment of the present invention.

FIG. 4 illustrates a block diagram of a system in accordance with an embodiment of the present invention.

### DETAILED DESCRIPTION OF THE INVENTION

The method and system utilizes an algorithm that accesses de-identified population data, remotely collected patient data, and a patient's medical record to predict that patient's clinical outcome. These predicted outcomes, or clinical trajectories, can be used to give immediate feedback to patients and may reinforce short-term compliance by showing the long-term results of their behavior.

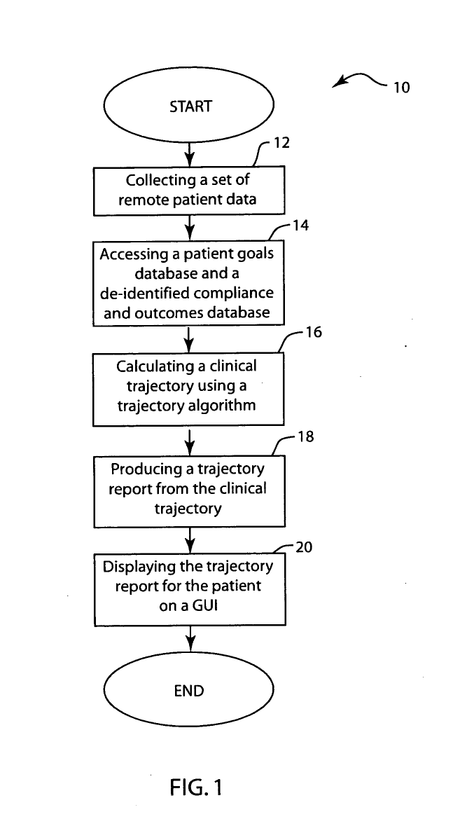

Referring to FIG. 1, a method 10 is illustrated in flow chart form. In step 12, a set of remote patient data is collected from a patient. The set of remote patient data is collected from the patient, usually in the patient's home environment, utilizing remote monitoring systems as known in the art, and those systems that may be contemplated later. The set of remote patient data may include, but is not limited to, blood pressure, weight, and self-assessment feedback (e.g. SF-12), as well as the degree of compliance with the treatment regimen. For example, whether the patient is taking his or her medication, getting exercise, or following a prescribed dietary plan.

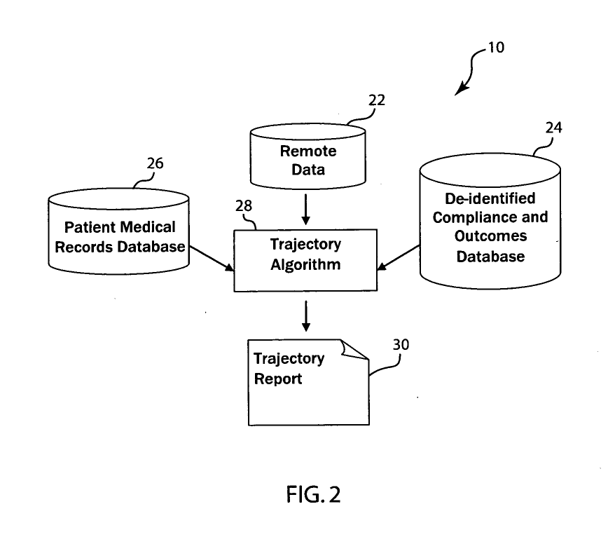

In step 14, data is retrieved from two databases. One of these databases, the patient medical record database 26 (FIG. 2), contains the patient's medical record. This data includes such information such as target weight, current H1c level, and treatment regimen, such as the recommended daily sodium intake for the patient or patient's prescriptions. This database may also contain the patient's current disease state or diagnosis. All of this data is specific to the particular patient. The de-identified compliance and outcomes database 24 (FIG. 2), contains a large amount of de-identified patient data. This data consists of outcomes, compliance levels, mortality levels, and disease progression rates, for a large population sample. A set of data is retrieved from this database that matches the specific patient's disease state or diagnosis, as well as other attributes such as age, sex, race, and co-morbidities.

In step 16, the trajectory algorithm 28 (FIG. 2) compares the patient specific data from the patient medical records database 26 (FIG. 2) with the large set of historical data representing many patients with a similar past diagnosis or disease state from the de-identified compliance and outcomes database 24 (FIG. 2). Since this data is historical and contains outcomes, a prediction, or trajectory, can be computed for the patient.

For example, the algorithm can use the de-identified population data of patients who had a similar diagnosis and who adhered to diet and medication regimens to determine average re-hospitalization rate, the average mortality, or the disease progression rate. Similarly, the algorithm can use the de-identified population data of patients who had a similar diagnosis and who did not adhere to diet and medication regimens to determine average re-hospitalization rate, the average mortality, or the disease progression rate.

Finally, the algorithm can use the de-identified population data of patients who had a similar diagnosis and who partially adhered to diet and medication regimens to determine average re-hospitalization rate, the average mortality, or the disease progression rate. The algorithm can develop many such estimates based on the degree of treatment regimen compliance.

In step 18, a trajectory report is produced from the clinical trajectory. The trajectory report includes a trajectory of the patient's condition if the patient continues to follow a prescribed treatment regimen compared to a trajectory of the patient's condition if the patient continues to ignore or not fully comply with the prescribed treatment regimen. In step 20, the trajectory report is displayed for the patient on a graphical user interface.

A block diagram of the method 10 is depicted in FIG. 2. Here, the remote data 22, as well as data from the patient medical record database 26 and the de-identified compliance and outcomes database 24 is entered into the trajectory algorithm 28. The trajectory algorithm 28 utilizes all of these data sources to calculate a trajectory report 30.

As an example, a congestive heart failure (CHF) patient participates in daily home monitoring and automated feedback sessions. The treatment regimen, consisting of several medications, a low sodium diet, moderate exercise and daily weight and blood pressure measurements, is required on a daily basis. The patient may comply with the treatment regimen for a few days and then begins to feel better. Through compliance sensors, or by self-assessment, the patient's compliance to the treatment regimen is monitored.

Based on the patient's compliance level, and other clinical factors, projections can be made using de-identified population data. The de-identified database can be queried for patients of similar demographics, disease stage, and compliance level. Various outcome metrics such as re-hospitalization rate, mortality and quality of life factors can be extrapolated and reported to the patient.

These extrapolations may provide the immediate feedback necessary for a patient to maintain the discipline necessary to follow a long-term treatment regimen. The method and system may deliver messages to the patient such as: “Continuing to exceed the recommended sodium intake will result in an additional two visits to the emergency room this year” or “By not measuring your blood pressure daily you are increasing your risk of stroke by 5 times”.

To illustrate this concept more clearly, consider a person attempting to lose weight through dieting and exercise. The effect of over-indulging in some high calorie food or skipping an exercise session will not be immediately apparent when the patient is next weighed. But if the weight scale could extrapolate the effect of this behavior change, the weight scale would indicate a significant weight gain. By not following the diet plan, you are placing yourself on another, less beneficial, trajectory. These trajectories can be measured in re-hospitalization rates, clinical disease classification (NYHA CHF Class), quality of life indices, or mortality rates.

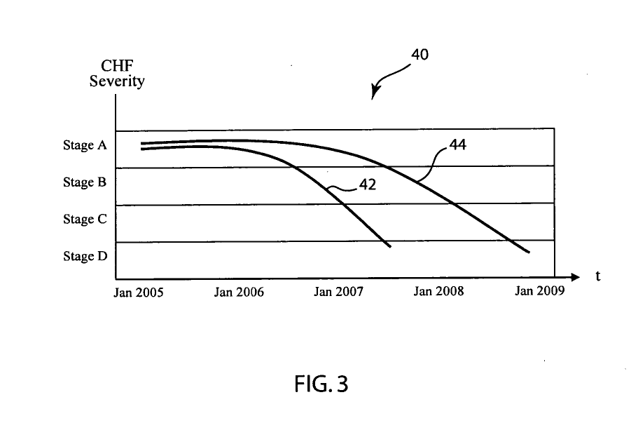

FIG. 3 illustrates a sample trajectory report 40, as would be displayed to a patient having congestive heart failure. In this sample trajectory report 40, the x-axis is labeled “t” for time in yearly increments, and the y-axis represents a severity of congestive heart failure (CHF) in stages, wherein the most severe stage of congestive heart failure is NYHA stage D at the bottom of the y-axis and stage A is the least severe level of congestive heart failure at the top y-axis. The sample trajectory report 40 includes a no compliance curve 42 and a compliance curve 44, both of which start in the patient's current condition. Here, the patient is in stage A in January, 2005. As described above, as the method utilizes the collected patient data and the database data in the trajectory algorithm, the trajectory algorithm calculates trajectories for the patient if a prescribed treatment is adhered to, as well as if the prescribed treatment is not adhered to. These two trajectories are illustrated in this sample trajectory report 40 in FIG. 3 as the no compliance curve 42 and the compliance curve 44, respectively. In practice, the algorithm will compute not only the trajectories for both with and without compliance, but also trajectories based on levels of partial compliance for each patient (not pictured).

Still referring to FIG. 3, if the patient in this case does not comply with the prescribed treatment regimen, then following the no compliance curve 42, that patient will enter into stage B prior to January, 2007, and will enter stage C congestive heart failure in or around January, 2007. Still following the no compliance curve 42, that patient will enter stage D somewhere in mid 2007.

Following the compliance curve 44, the patient will not enter stage B until mid 2007, which coincides with the no compliance curve 42 end point. Still following the compliance curve 44, if the patient complies with the prescribed treatment regimen, that patient will not enter stage C until after January, 2008, and will not enter stage D until January, 2009. It is clear from this illustration that the patient in this case will delay entry into stage D for roughly a year and a half if the patient complies with the prescribed treatment plan. It is clear from this sample trajectory report 40 that such increase in feedback to patients will likely result in better compliance to prescribed treatment regimens.

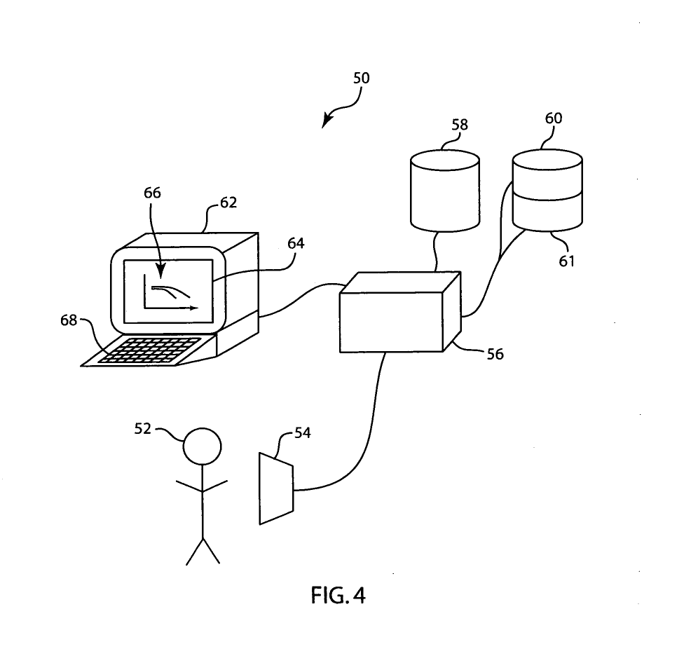

It should be understood that the method may be implemented as software and run on an appropriate system including a storage medium, a processor, an electronic device such as a computer, laptop, PDA, or other similar device, and be compatible with the remote sensing system as well as the appropriate databases. FIG. 4 illustrates an embodiment of this system.

Referring to FIG. 4, the computer code embodying the software is stored in the storage media 58. The remote sensing system 54 collects the remote patient data from the patient 52 and sends the remote patient data to the processor 56. Executing the computer code, the processor 56 utilizes the trajectory algorithm to calculate a trajectory report with the patient data from the patient 52 as well as with additional data from the patient medical record database 60 and/or the de-identified compliance and outcomes database 61. Once the clinical trajectories are calculated, a trajectory report 66 is produced, and displayed on a graphical user interface 64 of the electronic device 62. The electronic device 62 further includes an input/output device 68 so that a patient 52 may manipulate the sample trajectory report 66, save or forward the report 66, or even request a new report with different parameters or involving a separate and distinct health condition.

The present invention has been described in terms specific embodiments incorporating details to facilitate the understanding the principles of construction and operation of the invention. Such reference herein to specific embodiments and details thereof is not intended to limit scope of the claims appended hereto. It will be apparent to those skilled in the art that modifications may be made in the embodiment chosen for illustration without departing from the spirited scope of the invention.

We claim:

1. A method of computing a set of clinical trajectories of a chronic disease patient, the method comprising:
collecting a set of patient data from the chronic disease patient;
accessing a database for a set of compiled data; and
calculating the set of clinical trajectories with a trajectory algorithm, wherein the trajectory algorithm utilizes the set of remote patient data and the set of compiled data.

2. The method as claimed in claim 1, wherein the database is a patient medical record database.

3. The method as claimed in claim 1, wherein the database is a de-identified compliance and outcomes database.

4. The method as claimed in claim 1, wherein the set of clinical trajectories includes:
a compliance trajectory, the compliance trajectory illustrating a first predicted patient condition when the chronic disease patient adheres to a prescribed treatment regimen;
a first non-compliance trajectory, the first non-compliance trajectory illustrating a second predicted patient condition when the chronic disease patient does not adhere to the prescribed treatment regimen; and
a second non-compliance trajectory, the second non-compliance trajectory illustrating a third predicted patient condition when the chronic disease patient partially adheres to the prescribed treatment regimen.

5. The method as claimed in claim 4, further comprising producing a trajectory report, wherein the trajectory report includes a comparison of any of the set of clinical trajectories.

6. The method as claimed in claim 5, further comprising displaying the trajectory report on a graphical user interface.

7. A system for computing a set of clinical trajectories of a chronic disease patient, the system comprising:
a remote sensing system configured to collect a set of patient data from the chronic disease patient;
a storage media for storing a computer application; and
a processing unit coupled to the remote sensing system and the storage media and configured to execute the computer application, and further configured to receive the set of patient data from the remote sensing system,
wherein when the computer application is executed, a database having a set of compiled data is accessed and a set of clinical trajectories is calculated with a trajectory algorithm, and further wherein the trajectory algorithm utilizes a set of remote patient data and a set of compiled data when the trajectory algorithm calculates the set of clinical trajectories.

8. The system as claimed in claim 7, wherein the database is a patient medical record database.

9. The system as claimed in claim 7, wherein the database is a de-identified compliance and outcomes database.

10. The system as claimed in claim 7, wherein the set of clinical trajectories includes:
a compliance trajectory, the compliance trajectory illustrating a first predicted patient condition when the chronic disease patient adheres to a prescribed treatment regimen;
a first non-compliance trajectory, the first non-compliance trajectory illustrating a second predicted patient condition when the chronic disease patient does not adhere to the prescribed treatment regimen; and
a second non-compliance trajectory, the second non-compliance trajectory illustrating a third predicted patient condition when the chronic disease patient partially adheres to the prescribed treatment regimen.

11. The system as claimed in claim 10, further comprising a trajectory report produced when the trajectory algorithm calculates the set of clinical trajectories, wherein the trajectory report includes a comparison of any of the set of clinical trajectories.

12. The system as claimed in claim 11, further comprising a graphical user interface configured to display the trajectory report.

13. A method of computing a set of clinical trajectories, the method comprising:
collecting a set of patient data from a chronic disease patient;
accessing a patient medical records database for a set of compiled patient medical data and a de-identified compliance and outcomes database for a set of compiled population sample data;
calculating the set of clinical trajectories with a trajectory algorithm, wherein the trajectory algorithm utilizes the set of remote patient data, the set of compiled patient medical data, and the set of compiled population sample data; and
producing a trajectory report, wherein the trajectory report includes a comparison of any of the set of clinical trajectories;
wherein the set of clinical trajectories includes a compliance trajectory, the compliance trajectory illustrating a first predicted patient condition when the chronic disease patient adheres to a prescribed treatment regimen;
a first non-compliance trajectory, the first non-compliance trajectory illustrating a second predicted patient condition when the chronic disease patient does not adhere to the prescribed treatment regimen; and
a second non-compliance trajectory, the second non-compliance trajectory illustrating a third predicted patient condition when the chronic disease patient partially adheres to the prescribed treatment regimen.

14. The method as claimed in claim 13, further comprising displaying the trajectory report on a graphical user interface.
